(19) United States
(12) Patent Application Publication
(10) Pub. No.: US 2026/0289937 A1
(43) Pub. Date: Sep. 24, 2026

(54) ARRANGEMENT FOR DRIVER ASSISTANCE SYSTEM

(71) Applicant: SAINT-GOBAIN GLASS FRANCE, COURBEVOIE (FR)

(72) Inventors: Markus KEWITZ, HERZOGENRATH (DE); Julian GREVERATH, HERZOGENRATH (DE); Valentin SCHULZ, HERZOGENRATH (DE); Jan HAGEN, HERZOGENRATH (DE)

(21) Appl. No.: 18/880,480

(22) PCT Filed: Jul. 21, 2023
(86) PCT No.: PCT/EP2023/070254

§ 371 Date: Dec. 31, 2024

(30) Foreign Application Priority Data
Jul. 29, 2022 (EP) 22187682.4

(51) Int. Cl. G06V 10/147; B60R 1/29; B60W 40/08; B60W 50/14; G06V 20/59; G06V 40/19

(52) U.S. Cl. CPC G06V 10/147; B60R 1/29; B60W 40/08; B60W 50/14; G06V 20/597; G06V 40/19; B60R 2300/103; B60R 2300/20; B60R 2300/8006; B60W 2040/0818; B60W 2050/143; B60W 2050/146; B60W 2420/403; B60W 2540/225; B60W 2540/229

(57) ABSTRACT

An arrangement for a driver assistance system of a vehicle for monitoring at least one vehicle user, includes a radiation source for emitting near-infrared radiation, a radiation receiver for receiving near-infrared radiation, a thermal imaging camera, and a windshield including an outer pane with an outer-side surface and an interior-side surface and an inner pane with an outer-side surface and an interior-side surface, which are connected to one another via a thermoplastic intermediate layer, wherein a functional layer reflecting near-infrared radiation is arranged on the interior-side surface of the outer pane or on the outer-side surface of the inner pane, and a functional layer reflecting thermal radiation is arranged on the interior-side surface of the inner pane.

The invention relates to an arrangement having a windshield, a radiation source for emitting near-infrared radiation, a radiation receiver for receiving near-infrared radiation and a thermal imaging camera for a driver assistance system of a vehicle, which enables monitoring of at least one vehicle user, in particular the driver. Furthermore, the invention relates to the use of the arrangement in a driver assistance system, to a driver assistance system of a vehicle comprising such an arrangement, and to a method for monitoring at least one vehicle user, in particular the driver of a vehicle.

Modern vehicles are often equipped with electronic driver assistance systems that support the driver in guiding the vehicle, for example by automatically applying the brakes if there is a risk of a collision or automatically keeping in a lane if the vehicle leaves the lane. Such driver assistance systems have proved very successful in practice, in particular if they have a monitoring function for the driver, for example to recognize driver fatigue at an early stage, but also to recognize excessive distraction from safe vehicle operation, for example by operating a cell phone.

For this purpose, it is known to scan the driver's face and in particular his or her eyes using near-infrared radiation, which is not visible to the naked eye and thus does not disturb the driver and other vehicle occupants. Thereby, algorithms may be used to capture the driver's gaze direction and gaze duration, which can indicate fatigue, for example, if the duration of gaze in a particular direction is unusually long (staring gaze). On the other hand, an averting of one's gaze from the direction of travel that is too frequent can indicate distraction. It is also possible to recognize facial expressions, which can also give an indication of the driver's condition.

EP 1 333 410 A2 discloses a device for the eye tracking of the driver of a vehicle.

DE 10 2014 115 958 A1 discloses a system for monitoring a driver of a vehicle, comprising an infrared flash for shining an infrared light onto the driver, an infrared camera for recording an image illuminated by the beam, including reflections, and a reflective infrared sheet incorporated into the windshield of the vehicle.

US 2015/0294169 A1, US 2020/0023739 A1 and US 2020/0143184 A1 also disclose driver assistance systems.

US 2020/143560 A1 discloses a driver assistance system for a vehicle comprising a radiation source that emits non-visible light that illuminates at least a portion of a driver of the vehicle. A specular-selective reflector is arranged at the windshield of the vehicle. The reflector reflects at least a portion of the non-visible light (such as infrared (IR) and/or near-infrared (NIR) radiation) incident at the reflector and allows visible light to pass through the reflector and windshield, so as to direct the emitted non-visible light toward the driver, while allowing the driver to view through the reflector at the windshield. The camera is arranged in the dashboard of the vehicle and has a field of view that is directed away from the driver that includes or encompasses the reflector.

U.S. Pat. No. 10,322,728 B1 discloses a system for determining the load on a driver of a vehicle that comprises a plurality of sensors, including image sensors in the vehicle interior, an audio sensor in the vehicle interior, vehicle data sensors and GPS data sensors. The system further comprises one or more processors configured to receive inputs from the plurality of sensors and process the received inputs to provide a driver heat change estimate, a driver facial expression estimate, a driver gesture estimate, and an on-board diagnostic and GPS estimate. The one or more processors are further configured to store the estimates in a memory, use the stored estimates to generate variance scores for each of the estimates, execute a machine learning algorithm to classify the driver behavior as normal or impaired based on the variance scores, and generate an alert indicating impaired driver behavior based on the classification.

WO 2022/157021 A1 discloses a projection arrangement for a head-up display (HUD), at least comprising a windshield, comprising an outer pane and an inner pane, which are connected to one another via a thermoplastic intermediate layer, with a HUD region and a projector, which is directed to the HUD region and which emits p-polarized radiation, wherein, on the surface of the outer pane facing the intermediate layer or on the surface of the inner pane facing the intermediate layer or inside the intermediate layer, a reflective coating is arranged, which is suitable for reflecting p-polarized radiation, and which has precisely one electrically conductive layer based on silver, and on the surface of the inner pane facing away from the intermediate layer, a thermal radiation-reflective coating is arranged, which comprises an electrically conductive layer based on a transparent conductive oxide. The reflective coating has IR-reflective properties due to the electrically conductive silver layer, such that it acts as a solar control coating that reduces heating of the vehicle interior by reflecting infrared components of solar radiation, particularly in the near-infrared range, for example in the range from 800 nm to 1500 nm.

Modern driver assistance systems operate with wavelengths in the range of approximately 1 μm (micrometer) to 2 μm, in particular with near-infrared radiation with a wavelength of 940 nm or with near-infrared radiation with a wavelength of 1400 nm or with near-infrared radiation with a wavelength of 1550 nm.

It is desirable to determine other information in addition to the near-infrared-based monitoring function, such as information on the vital status and/or comfort status of the driver and/or other vehicle users in the vehicle.

The object of the present invention is to provide an improved arrangement for a driver assistance system with a monitoring function for at least one vehicle user, which enables simple and reliable capturing of information about at least one vehicle user.

According to the proposal of the invention, these and further objects are achieved by an arrangement, a driver assistance system and a method according to the independent patent claims. Preferred embodiments result from the dependent claims.

The invention relates to an arrangement for a driver assistance system for a vehicle, in particular a motor vehicle, with a monitoring function of at least one vehicle user of the vehicle based on near-infrared radiation and thermal radiation.

The arrangement according to the invention for a driver assistance system of a vehicle for monitoring at least one vehicle user comprises a radiation source for emitting near-infrared radiation, a radiation receiver for receiving near-infrared radiation and a thermal imaging camera for receiving thermal radiation. The arrangement further comprises a windshield comprising an outer pane and an inner pane, which are connected to one another by a thermoplastic intermediate layer.

The windshield is provided to separate the interior from the external environment in a window opening of a vehicle. In the sense of the invention, the term “inner pane” refers to the pane of the windshield facing the vehicle interior. Outer pane means the pane facing the external environment.

The outer pane and the inner pane each have an outer-side and an interior-side surface and a peripheral side edge extending between them. In the context of the invention, the outer surface means the main surface which is provided to face the external environment when installed. In the context of the invention, the interior-side surface means the main surface which is intended to face the interior space when installed. The interior-side surface of the outer pane and the outer surface of the inner pane face one another and are connected to one another by the thermoplastic intermediate layer.

The outer-side surface of the outer pane is designated as side I. The interior-side surface of the outer pane is designated as side II. The outer-side surface of the inner pane is designated as side III. The interior-side surface of the inner pane is designated as side IV.

According to the invention, the windshield has a functional layer reflecting near-infrared radiation. The functional layer reflecting near-infrared radiation is suitable for reflecting near infrared radiation. The functional layer reflecting near-infrared radiation is arranged on the interior-side surface of the outer pane or on the outer-side surface of the inner pane.

In addition, the windshield has a functional layer reflecting thermal radiation. The functional layer reflecting thermal radiation is suitable for reflecting thermal radiation. The functional layer reflecting thermal radiation is arranged on the interior-side surface of the inner pane; in particular, the functional layer reflecting thermal radiation is designed as a coating of the interior-side surface of the inner pane.

The radiation source is arranged such that near-infrared radiation emitted from the radiation source is directed to the functional layer reflecting near-infrared radiation and can be reflected from the functional layer reflecting near-infrared radiation to the face of the vehicle user. Thus, the near-infrared radiation emitted by the radiation source strikes the functional layer reflecting near-infrared radiation directly without prior reflection and is reflected by it. For ease of reference, the near-infrared radiation reflected from the functional layer reflecting near-infrared radiation is designated as first reflection radiation. Thereby, the first reflection radiation strikes the face of the vehicle user and can be reflected by the face of the vehicle user back to the functional layer reflecting near-infrared radiation. For ease of reference, near-infrared radiation reflected from the face of the vehicle user is designated as second reflection radiation. The second reflection radiation impacting the functional layer reflecting near-infrared radiation is then reflected by the functional layer reflecting near-infrared radiation. For ease of reference, the near-infrared radiation reflected from the functional layer reflecting near-infrared radiation is designated as third reflection radiation. Thereby, the radiation receiver is arranged so that the third reflection radiation reflected from the functional layer reflecting near-infrared radiation can be reflected to the radiation receiver and received by the radiation receiver.

The thermal imaging camera and the functional layer reflecting thermal radiation are aligned so that thermal radiation emitted from the face of the vehicle user strikes the functional layer reflecting thermal radiation and is reflected by the functional layer reflecting thermal radiation in the direction of the thermal imaging camera and can be received by the thermal imaging camera.

Thus, in the arrangement according to the invention, the radiation source, the functional layer reflecting near-infrared radiation, the functional layer reflecting thermal radiation, the thermal imaging camera and the radiation receiver are arranged such that near-infrared radiation emitted from the radiation source can be reflected from the functional layer reflecting near-infrared radiation to the face of the vehicle user as first reflection radiation, the first reflection radiation can be reflected from the face of the vehicle user to the functional layer reflecting near-infrared radiation as second reflection radiation, and the second reflection radiation reflected from the functional layer reflecting near-infrared radiation as third reflection radiation can be reflected to the radiation receiver and received by the radiation receiver, and also arranged such that thermal radiation emitted from the face of the vehicle user can be reflected from the functional layer reflecting thermal radiation as reflected thermal radiation to the thermal imaging camera and received by the thermal imaging camera.

In the sense of the invention, near-infrared radiation is understood to mean radiation with wavelengths in the range of 800 nm to 2500 nm, preferably 800 nm to 1600 nm.

In the sense of the invention, thermal radiation is understood to mean radiation with wavelengths in the range from 5 μm (micrometers) to 14 μm, preferably 7 μm to 14 μm, particularly preferably 8 μm to 14 μm.

Glass panes have a high absorption rate for thermal radiation with wavelengths in the range of 5 μm to 14 μm. Without the functional layer reflecting thermal radiation applied to the interior-side surface of the inner pane, almost all thermal radiation emitted by a vehicle user in the direction of the windshield would thus be absorbed by the inner pane, and reception of reflected thermal radiation by means of a thermal imaging camera to determine information about the vehicle user would not be possible.

Preferably, the near-infrared radiation emitted by the radiation source is reflected only in a first sub-region of the windshield. Equally preferably, the third reflection radiation is reflected only in a second sub-region of the windshield.

Preferably, the thermal radiation emitted by the face of the vehicle user is reflected only in a third sub-region of the windshield.

The first sub-region, the second sub-region and the third sub-region may be separate, partially overlapping, or fully overlapping (i.e., identical).

Preferably, the first sub-region, the second sub-region and the third sub-region overlap completely; i.e., they are identical.

In a preferred embodiment, the functional layer reflecting near-infrared radiation is arranged on the interior-side surface of the outer pane. In this embodiment, the functional layer reflecting near-infrared radiation is designed in particular as a coating of the interior-side surface of the outer pane.

In an alternative preferred embodiment, the functional layer reflecting near-infrared radiation is arranged on the outer-side surface of the inner pane. In this embodiment, the functional layer reflecting near-infrared radiation is designed, in particular, as a coating on the outer-side surface of the inner pane.

Particularly preferred is the embodiment of an arrangement according to the invention in which the functional layer reflecting near-infrared radiation is arranged on the outer-side surface of the inner pane. This embodiment offers the advantage over the embodiment in which the functional layer reflecting near-infrared radiation is arranged on the interior-side surface of the outer pane that the near-infrared radiation and the second reflection radiation emitted by the radiation source do not have to pass through the thermoplastic intermediate layer before they strike the near-infrared radiation reflecting intermediate layer, and the first reflection radiation and the third reflection radiation likewise do not have to pass through the thermoplastic intermediate layer before they strike the face of the vehicle user and the radiation receiver, respectively.

The functional layer reflecting near-infrared radiation preferably extends over a large area of the windshield. The term “large area” means that the functional layer reflecting near-infrared radiation extends over at least 50%, at least 60%, at least 70%, at least 75% or preferably at least 90% of the windshield. However, the functional layer reflecting near-infrared radiation can also extend over only a sub-region of the windshield.

Particularly preferably, the functional layer reflecting near-infrared radiation extends over substantially the entire area of the windshield, i.e., over the entire area or the entire area with the exception of a peripheral edge region and optionally local regions that are intended to act as communication, sensor or camera windows to ensure the transmission of electromagnetic radiation through the windshield. The peripheral edge region has, for example, a width of up to 20 cm. It prevents the functional layer reflecting near-infrared radiation from coming into direct contact with the surrounding atmosphere, such that the functional layer reflecting near-infrared radiation in the interior of the windshield is protected from corrosion and damage.

The functional layer reflecting thermal radiation also preferably extends over a large area of the windshield. The term “large area” means that the functional layer reflecting thermal radiation extends over at least 50%, at least 60%, at least 70%, at least 75% or preferably at least 90% of the windshield. However, the functional layer reflecting thermal radiation can also extend over only a sub-region of the windshield.

Particularly preferably, the functional layer reflecting thermal radiation extends over substantially the entire area of the windshield, i.e., over the entire area or the entire area with the exception of a peripheral edge region and optionally local regions that are intended to act as communication, sensor or camera windows to ensure the transmission of electromagnetic radiation through the windshield. The peripheral edge region has, for example, a width of up to 20 cm.

Preferably, the functional layer reflecting near-infrared radiation comprises a layer system with at least one metal layer embedded between dielectric oxide or nitride layers, in particular at least one metallic silver layer.

In a particularly preferred embodiment of the arrangement according to the invention, the functional layer reflecting near-infrared radiation comprises a layer system with three silver layers embedded between dielectric oxide or nitride layers. The functional layer reflecting near-infrared radiation can, for example, be constructed like one of the layer systems described in WO 2013/104438 A1 and WO 2013/104439 A1 based on three silver layers.

In a preferred embodiment, the functional layer reflecting near-infrared radiation has at least three functional layers arranged one above the other, and each functional layer comprises at least
a layer of optically highly refractive material with a refractive index of greater than or equal to 2.1,
above the layer of optically high-index material, a smoothing layer containing at least one non-crystalline oxide,
above the smoothing layer, a first adaptation layer,
above the first adaptation layer, an electrically conductive layer and
above the electrically conductive layer, a second adaptation layer, wherein the total layer thickness of all electrically conductive layers is from 25 nm to 75 nm and the functional layer reflecting near-infrared radiation has a sheet resistance of less than 1.3 ohm/square, preferably less than 1.0 ohm/square.

In this preferred embodiment, the layer of optically highly refractive material preferably has a refractive index n of 2.1 to 2.5, particularly preferably of 2.1 to 2.3.

In this preferred embodiment, the layer of optically highly refractive material preferably contains at least one silicon/metal mixed nitride, particularly preferably silicon/zirconium mixed nitride. This is particularly advantageous with regard to the sheet resistance of the functional layer reflecting near-infrared radiation. The mixed silicon/zirconium nitride preferably has dopants. The layer of an optically highly refractive material can contain, for example, an aluminum-doped silicon/zirconium mixed nitride (SiZrNₓ:Al).

In this preferred embodiment, the silicon/zirconium mixed nitride is preferably deposited by magnetic field-assisted sputtering with a target that contains 40 wt. % up to 70 wt. % silicon, from 30 wt. % up to 60 wt. % zirconium and from 0 wt. % up to 10 wt. % aluminum along with production-related admixtures. The target particularly preferably contains from 45 wt. % up to 60 wt. % silicon, from 35 wt. % to 55 wt. % zirconium and from 3 wt. % to 8 wt. % aluminum along with production-related admixtures. The deposition of the silicon/zirconium mixed nitride is preferably carried out with the addition of nitrogen as reaction gas during cathode sputtering.

However, the layer of optically highly refractive material can also contain, for example, at least silicon/aluminum mixed nitride, silicon/hafnium mixed nitride, or silicon/titanium mixed nitride. The layer of optically highly refractive material can alternatively contain, for example, Nb₂O₅, Bi₂O₃, TiO₂, Zr₃N₄ and/or AlN.

In this preferred embodiment, the layer thickness of each layer of optically highly refractive material arranged between two electrically conductive layers is preferably from 35 nm to 70 nm, particularly preferably from 45 nm to 60 nm. The thickness of the lowermost layer of optically highly refractive material is preferably from 10 nm to 40 nm.

In an advantageous design in this preferred embodiment, a cover layer is arranged above the uppermost functional layer. The cover layer can contain, for example, silicon nitride and/or tin oxide.

In this preferred embodiment, the cover layer preferably contains at least one optically highly refractive material with a refractive index of greater than or equal to 2.1. The cover layer particularly preferably contains at least one silicon/metal mixed nitride, in particular silicon/zirconium mixed nitride, such as aluminum-doped silicon/zirconium mixed nitride. However, the cover layer can also contain other silicon/metal mixed nitrides, for example silicon/aluminum mixed nitride, silicon/hafnium mixed nitride or silicon/titanium mixed nitride. Alternatively, the cover layer can also contain, for example Nb₂O₅, Bi₂O₃, TiO₂, Zr₃N₄ and/or AlN.

The thickness of the cover layer of this preferred embodiment is preferably from 10 nm to 40 nm. This achieves particularly good results.

In this preferred embodiment, the smoothing layer contains at least one non-crystalline oxide. The oxide may be amorphous or partially amorphous (and therefore partially crystalline), but is not completely crystalline. The non-crystalline smoothing layer has a low roughness and therefore forms an advantageously smooth surface for the layers to be applied above the smoothing layer. The non-crystalline smoothing layer also effects an improved surface structure of the layer, which is preferably the first adaptation layer, deposited directly above the smoothing layer. The smoothing layer can contain, for example, at least one oxide of one or more of the elements tin, silicon, titanium, zirconium, hafnium, zinc, gallium and indium.

In this preferred embodiment, the smoothing layer preferably contains a non-crystalline mixed oxide. The smoothing layer most preferably contains a tin/zinc mixed oxide. The mixed oxide can have dopants. The smoothing layer can contain, for example, an antimony-doped tin/zinc mixed oxide (SnZnOₓ:Sb). The mixed oxide preferably has a sub-stoichiometric oxygen content. A method for the production of tin-zinc mixed oxide coatings by reactive cathode sputtering is known, for example, from DE 198 48 751 C1. The tin-zinc mixed oxide is preferably deposited with a target that contains from 25 wt. % to 80 wt. % zinc, from 20 wt. % up to 75 wt. % tin and from 0 wt. % up to 10 wt. % antimony along with production-related admixtures. The target particularly preferably contains from 45 wt. % up to 75 wt. % zinc, from 25 wt. % to 55 wt. % tin and from 1 wt. % up to 5 wt. % antimony along with production-related admixtures of other metals. The tin-zinc mixed oxide is deposited with the addition of oxygen as a reaction gas during cathode sputtering.

The layer thickness of a smoothing layer in this preferred embodiment is preferably from 3 nm to 20 nm, particularly preferably from 4 nm to 12 nm. The smoothing layer preferably has a refractive index of less than 2.2.

In this preferred embodiment, the electrically conductive layer preferably contains at least one metal, for example gold or copper, or an alloy, particularly preferably silver or a silver-containing alloy. However, the electrically conductive layer can also contain other electrically conductive materials known to the person skilled in the art.

In an advantageous design of this preferred embodiment, the electrically conductive layer contains at least 90 wt. silver, particularly preferably at least 99.9 wt. % silver. The electrically conductive layer is preferably applied using common metal layer deposition methods, for example vacuum methods such as magnetic field-assisted sputtering.

In this preferred embodiment, the electrically conductive layer preferably has a layer thickness of from 8 nm to 25 nm, particularly preferably from 10 nm to 20 nm. This is particularly advantageous with regard to the transparency and sheet resistance of the electrically conductive layer.

In this preferred embodiment, the first adaptation layer and/or the second adaptation layer preferably contains zinc oxide ZnO_{1-δ} with 0≤δ≤0.01, for example aluminum-doped zinc oxide (ZnO:Al). The zinc oxide is preferably deposited sub-stoichiometrically with respect to the oxygen in order to avoid a reaction of excess oxygen with the silver-containing layer. The zinc oxide layer is preferably deposited by magnetic field-assisted sputtering. The target preferably contains from 85 wt. % to 100 wt. % zinc oxide and from 0 wt. % up to 15 wt. % aluminum along with production-related admixtures. The target particularly preferably contains from 90 wt. % to 95 wt. % zinc oxide and from 5 wt. % up to 10 wt. % aluminum along with production-related admixtures. Alternatively, the target preferably contains from 95 wt. % to 99 wt. % zinc and from 1 wt. % to 5 wt. % aluminum, wherein the deposition of the layers is carried out with the addition of oxygen as a reaction gas. The layer thicknesses of the first adaptation layer and the second adaptation layer are preferably from 3 nm to 20 nm, particularly preferably from 4 nm to 12 nm.

In an advantageous design of this preferred embodiment, at least one functional layer comprises at least one blocker layer. The blocker layer is in direct contact with the electrically conductive layer and is arranged directly above or directly below the electrically conductive layer. No additional layer is therefore arranged between the electrically conductive layer and the blocker layer. The functional layer can also comprise two blocker layers, preferably with one blocker layer immediately above and one blocker layer immediately below the electrically conductive layer. Particularly preferably, each functional layer comprises at least one such blocker layer. The blocker layer preferably contains niobium, titanium, nickel, chromium and/or alloys thereof, particularly preferably nickel-chromium alloys. The thickness of the blocker layer is preferably from 0.1 nm to 2 nm. This achieves good results. A blocker layer directly below the electrically conductive layer serves in particular for stabilizing the electrically conductive layer during a temperature treatment and improves the optical quality of the functional layer reflecting near-infrared radiation. A blocker layer directly above the electrically conductive layer prevents contact of the sensitive electrically conductive layer with the oxidizing reactive atmosphere during the deposition of the following layer by reactive cathode sputtering, for example of the second adaptation layer, which preferably contains zinc oxide.

Typically, block layers with a thickness of approximately 0.5 nm or even a few nanometers are used in this preferred embodiment.

In a further preferred embodiment, the functional layer reflecting near-infrared radiation has at least three functional layers arranged one above the other, and each functional layer comprises at least
one anti-reflective layer,
above the anti-reflective layer, one first adaptation layer, and
above the first adaptation layer, one electrically conductive layer, wherein at least one functional layer comprises an anti-reflective layer, which comprises at least
a layer of a dielectric material with a refractive index of less than 2.1, and
a layer of an optically highly refractive material with a refractive index of greater than or equal to 2.1.

The layer of an optically highly refractive material can be arranged above or below the layer of a dielectric material with a refractive index of less than 2.1. The layer of an optically highly refractive material is preferably arranged above the layer of a dielectric material with a refractive index of less than 2.1.

In this further preferred embodiment, the thickness of the layer of an optically highly refractive material with a refractive index of greater than or equal to 2.1 is preferably from 10% to 99%, particularly preferably from 25% to 75%, most preferably from 33% to 67% of the thickness of the anti-reflective layer containing such layer of an optically highly refractive material.

In a particularly advantageous design of this further preferred embodiment, each anti-reflective layer arranged between two electrically conductive layers comprises at least one layer of a dielectric material with a refractive index of less than 2.1 and one layer of an optically highly refractive material with a refractive index of greater than or equal to 2.1.

In this further preferred embodiment, the anti-reflective layers arranged between two electrically conductive layers preferably have layer thicknesses of 35 nm to 70 nm, particularly preferably 45 nm to 60 nm.

In this further preferred embodiment, the layer of an optically highly refractive material preferably has a refractive index n of from 2.1 to 2.5, particularly preferably from 2.1 to 2.3.

In this further preferred embodiment, the layer of an optical high refractive index material with a refractive index of greater than or equal to 2.1 preferably contains at least one silicon/metal mixed nitride, particularly preferably at least one silicon/zirconium mixed nitride. This is particularly advantageous with regard to the sheet resistance of the functional layer reflecting near-infrared radiation. The mixed silicon/zirconium nitride preferably has dopants. The layer of an optically highly refractive material can contain, for example, an aluminum-doped mixed silicon/zirconium nitride.

The silicon/zirconium mixed nitride is preferably deposited by magnetic field-assisted cathode sputtering with a target that contains 40 wt. % up to 70 wt. % silicon, from 30 wt. % up to 60 wt. % zirconium and from 0 wt. % up to 10 wt. % aluminum along with production-related admixtures. The target particularly preferably contains from 45 wt. % up to 60 wt. % silicon, from 35 wt. % to 55 wt. % zirconium and from 3 wt. % to 8 wt. % aluminum along with production-related admixtures. The deposition of the silicon/zirconium mixed nitride is preferably carried out with the addition of nitrogen as reaction gas during cathode sputtering.

However, in this further preferred embodiment, the layer of an optically highly refractive material can also include, for example, at least silicon/aluminum mixed nitride, silicon/hafnium mixed nitride or silicon/titanium mixed nitride. The layer of optically highly refractive material can alternatively contain, for example, Nb₂O₅, Bi₂O₃, TiO₂, Zr₃N₄ and/or AlN.

In this further preferred embodiment, the thickness of the layer of an optically highly refractive material is preferably from 3.5 nm to 69 nm.

The layer of a dielectric material with a refractive index of less than 2.1 preferably has a refractive index n between 1.6 and 2.1, particularly preferably between 1.9 and 2.1.

The layer of a dielectric material of this further preferred embodiment preferably contains at least one oxide, for example tin oxide, and/or a nitride, particularly preferably silicon nitride. The layer of a dielectric material preferably has a thickness of 0.3 nm to 63 nm.

In this further preferred embodiment, the electrically conductive layer preferably contains at least one metal, for example copper or gold, or an alloy, particularly preferably silver or an alloy containing silver. However, the electrically conductive layer can also contain other electrically conductive materials known to the person skilled in the art.

In an advantageous design of this further preferred embodiment, the electrically conductive layer contains at least 90 wt. % silver, particularly preferably at least 99.9 wt. silver. The electrically conductive layer is preferably applied using common metal layer deposition methods, for example vacuum methods such as magnetic field-assisted sputtering.

In this further preferred embodiment, the electrically conductive layer preferably has a layer thickness of from 8 nm to 25 nm, particularly preferably from 10 nm to 19 nm. This is particularly advantageous with regard to transparency, color neutrality and sheet resistance of the electrically-conductive layer.

The total layer thickness of all electrically conductive layers of this further preferred embodiment is preferably from 40 nm to 80 nm, particularly preferably from 45 nm to 60 nm.

In an advantageous design of this further preferred embodiment, the functional layer reflecting near-infrared radiation comprises at least one smoothing layer in at least one of the functional layers. The smoothing layer is arranged below one of the first adaptation layers, preferably between the anti-reflective layer and the first adaptation layer of at least one functional layer of the functional layer reflecting near-infrared radiation. The smoothing layer is particularly preferably in direct contact with the first adaptation layer. The smoothing layer yields an optimization, in particular smoothing of the surface for an electrically conductive layer subsequently applied above. An electrically conductive layer deposited on a smoother surface has a higher transmittance with a simultaneously lower sheet resistance.

In a particularly preferred design of this further preferred embodiment, each functional layer of the functional layer reflecting near-infrared radiation comprises a smoothing layer arranged below the first adaptation layer, preferably between the anti-reflective layer and the first adaptation layer.

In this further preferred embodiment, the smoothing layer preferably contains at least one non-crystalline oxide. The oxide may be amorphous or partially amorphous (and therefore partially crystalline), but is not completely crystalline. The non-crystalline smoothing layer has a low roughness and therefore forms an advantageously smooth surface for the layers to be applied above the smoothing layer. The non-crystalline smoothing layer also effects an improved surface structure of the layer, which is preferably the first adaptation layer, deposited directly above the smoothing layer. The smoothing layer can contain, for example, at least one oxide of one or more of the elements tin, silicon, titanium, zirconium, hafnium, zinc, gallium and indium.

The smoothing layer of this further preferred embodiment particularly preferably contains a non-crystalline mixed oxide. The smoothing layer most preferably contains a tin/zinc mixed oxide. The mixed oxide can have dopants. The smoothing layer can contain, for example, an antimony-doped tin/zinc mixed oxide. The mixed oxide preferably has a sub-stoichiometric oxygen content. A method for the production of tin-zinc mixed oxide coatings by reactive cathode sputtering is known, for example, from DE 198 48 751 C1. The tin-zinc mixed oxide is preferably deposited with a target that contains from 25 wt. % to 80 wt. % zinc, from 20 wt. % up to 75 wt. % tin and from 0 wt. % up to 10 wt. % antimony along with production-related admixtures. The target particularly preferably contains from 45 wt. % up to 75 wt. % zinc, from 25 wt. % to 55 wt. % tin and from 1 wt. % up to 5 wt. % antimony along with production-related admixtures of other metals. The tin-zinc mixed oxide is deposited with the addition of oxygen as a reaction gas during cathode sputtering.

The layer thickness of a smoothing layer of this further preferred embodiment is preferably from 3 nm to 20 nm, particularly preferably from 4 nm to 12 nm. The smoothing layer preferably has a refractive index of less than 2.2.

In an advantageous design of this further preferred embodiment, each functional layer comprises a second adaptation layer arranged above the electrically conductive layer. This is particularly advantageous with regard to the sheet resistance of the functional layer reflecting near-infrared radiation.

In this further preferred embodiment, the first adaptation layer and/or the second adaptation layer preferably contains zinc oxide ZnO_{1-δ} with 0≤δ≤0.01. The first adaptation layer and/or the second adaptation layer also preferably contain dopants. The first adaptation layer and/or the second adaptation layer can contain aluminum-doped zinc oxide, for example. The zinc oxide is preferably deposited sub-stoichiometrically with respect to the oxygen in order to avoid a reaction of excess oxygen with the silver-containing layer. The zinc oxide layer is preferably deposited by magnetic field-assisted sputtering. The target preferably contains from 85 wt. % to 100 wt. % zinc oxide and from 0 wt. % up to 15 wt. % aluminum along with production-related admixtures. The target particularly preferably contains from 90 wt. % to 95 wt. % zinc oxide and from 5 wt. % up to 10 wt. % aluminum along with production-related admixtures. Alternatively, the target preferably contains from 95 wt. % to 99 wt. % zinc and from 1 wt. % to 5 wt. % aluminum, wherein the deposition of the layers is carried out with the addition of oxygen as a reaction gas. The layer thicknesses of the first adaptation layer and the second adaptation layer are preferably from 3 nm to 20 nm, particularly preferably from 4 nm to 12 nm.

In a preferred design in this further preferred embodiment, a further anti-reflective layer is applied above the uppermost functional layer. The further anti-reflective layer improves the optical properties of the functional layer reflecting near-infrared radiation.

In this further preferred embodiment, the uppermost anti-reflective layer is then the anti-reflective layer that is arranged above the functional layers. In this further preferred embodiment, the lowermost anti-reflective layer is the anti-reflective layer with the smallest distance to the surface on which the functional layer reflecting infrared radiation is applied. The lowermost anti-reflective layer is the anti-reflective layer of the lowest functional layer. The uppermost and lowermost anti-reflective layers are not arranged between two electrically conductive layers. The uppermost and/or lowermost anti-reflective layer is preferably a layer of an optically highly refractive material with a refractive index of greater than or equal to 2.1. The uppermost and/or the lowermost anti-reflective layer particularly preferably contains at least one silicon/zirconium mixed nitride, such as an aluminum-doped silicon/zirconium mixed nitride. However, the uppermost and/or lowermost anti-reflective layers can also contain a dielectric material with a refractive index of less than 2.1, for example silicon nitride or tin oxide. For example, the uppermost and/or the lowermost anti-reflective layers can also each comprise a layer of an optically highly refractive material and a layer of a dielectric material with a refractive index of less than 2.1. The thickness of the uppermost and lowermost anti-reflective layers is preferably from 10 nm to 40 nm. This achieves particularly good results.

In an advantageous design of this further preferred embodiment, at least one functional layer comprises at least one blocker layer. The blocker layer is in direct contact with the electrically conductive layer and is arranged directly above or directly below the electrically conductive layer. No additional layer is therefore arranged between the electrically conductive layer and the blocker layer. The functional layer can also comprise two blocker layers, preferably with one blocker layer immediately above and one blocker layer immediately below the electrically conductive layer. Particularly preferably, each functional layer comprises at least one such blocker layer. The blocker layer preferably contains niobium, titanium, nickel, chromium and/or alloys thereof, particularly preferably nickel-chromium alloys. The thickness of the blocker layer is preferably from 0.1 nm to 5 nm, particularly preferably from 0.1 nm to 2 nm. This achieves particularly good results. A blocker layer directly below the electrically conductive layer serves in particular for stabilizing the electrically conductive layer during a temperature treatment and improves the optical quality of the functional layer reflecting near-infrared radiation. A blocker layer directly above the electrically conductive layer prevents contact of the sensitive electrically conductive layer with the oxidizing reactive atmosphere during the deposition of the following layer by reactive cathode sputtering, for example of the second adaptation layer, which preferably contains zinc oxide.

Preferably, the functional layer reflecting thermal radiation contains a transparent conductive oxide (TCO). Such coatings are corrosion-resistant and may be used on exposed surfaces. The functional layer reflecting thermal radiation preferably contains indium tin oxide (ITO), which has proved particularly successful, particularly due to low resistivity and low scattering in terms of sheet resistance. However, the functional layer reflecting thermal radiation can also contain, for example, indium-zinc mixed oxide (IZO), gallium-doped tin oxide (GZO), fluorine-doped tin oxide (SnO₂:F) or antimony-doped tin oxide (SnO₂:Sb). Most preferably, the functional layer reflecting thermal radiation contains indium tin oxide.

In a preferred embodiment, the functional layer reflecting thermal radiation is constructed as described in WO 2018/206236 A1 and, starting from the interior-side surface of the inner pane, comprises at least
a blocking layer against alkali diffusion with a refractive index of at least 1.9,
a dielectric lower anti-reflective coating with a refractive index of 1.3 to 1.8,
an electrically conductive layer,
a dielectric barrier layer for regulating oxygen diffusion with a refractive index of at least 1.9, and
a dielectric upper anti-reflective coating with a refractive index of 1.3 to 1.8.

In this embodiment, the electrically conductive layer of the functional layer reflecting thermal radiation contains a transparent conductive oxide, preferably indium tin oxide, indium zinc mixed oxide (IZO), gallium-doped tin oxide (GZO), fluorine-doped tin oxide (SnO₂:F) or antimony-doped tin oxide (SnO₂:Sb), particularly preferably indium tin oxide, and preferably has a refractive index of 1.7 to 2.3.

In this embodiment, the thickness of the electrically conductive layer of the functional layer reflecting thermal radiation is preferably from 50 nm to 130 nm, particularly preferably from 60 nm to 100 nm, for example from 65 nm to 80 nm. This achieves particularly good results in terms of electrical conductivity while maintaining sufficient optical transparency.

In this embodiment, the refractive index of the lower anti-reflective coating is preferably at most 1.8, particularly preferably from 1.3 to 1.8. The thickness of the lower anti-reflective coating is preferably from 5 nm to 50 nm, preferably from 10 nm to 30 nm, for example from 10 nm to 20 nm.

In this embodiment, the refractive index of the upper anti-reflective coating is preferably at most 1.8, particularly preferably from 1.3 to 1.8. The thickness of the upper anti-reflective coating is preferably from 10 nm to 100 nm, particularly preferably from 30 nm to 70 nm, for example from 45 nm to 55 nm.

In a particularly advantageous design, the functional layer reflecting thermal radiation in this embodiment has both a lower anti-reflective layer below the electrically conductive layer and an upper anti-reflective layer above the electrically conductive layer.

The anti-reflective coatings preferably contain an oxide or fluoride, particularly preferably silicon oxide, aluminum oxide, magnesium fluoride or calcium fluoride. The silicon oxide can have dopants and is preferably doped with aluminum (SiO₂:Al), with boron (SiO₂:B), with titanium (SiO₂:Ti) or with zirconium (SiO₂:Zr). Alternatively, the layers can also contain aluminum oxide (Al₂O₃), for example.

In a particularly advantageous design, the upper anti-reflective layer in this embodiment is the uppermost layer of the functional layer reflecting thermal radiation.

It has been shown that the oxygen content of the electrically conductive layer, particularly if it is based on a TCO, has a significant influence on its properties, particularly transparency and conductivity. The production of the pane typically involves a thermal treatment, such as a thermal prestressing process, wherein oxygen can diffuse to the conductive layer and oxidize it. In an advantageous design, the functional layer reflecting thermal radiation in this embodiment comprises a dielectric barrier layer for regulating oxygen diffusion with a refractive index of at least 1.9 between the electrically conductive layer and the upper anti-reflective layer. The barrier layer serves to adjust the oxygen supply to an optimum level. Particularly good results are obtained if the refractive index of the barrier layer is from 1.9 to 2.5.

The dielectric barrier layer for regulating oxygen diffusion contains at least a metal, a nitride or a carbide. For example, the barrier layer can contain titanium, chromium, nickel, zirconium, hafnium, niobium, tantalum or tungsten, or a nitride or carbide of tungsten, niobium, tantalum, zirconium, hafnium, chromium, titanium, silicon or aluminum. In a preferred design, the barrier layer contains silicon nitride (Si₃N₄) or silicon carbide, in particular silicon nitride (Si₃N₄), with which particularly good results are achieved. The silicon nitride can have dopants and in a preferred additional form is doped with aluminum (Si₃N₄:Al), with zirconium (Si₃N₄:Zr), with titanium (Si₃N₄:Ti), or with boron (Si₃N₄:B). During a temperature treatment after the application of the functional layer reflecting thermal radiation, the silicon nitride can be partially oxidized. A barrier layer deposited as Si₃N₄ then contains SiₓN_{y}O_{z} after temperature treatment, with oxygen content typically ranging from 0 at % to 35 at %.

The thickness of the barrier layer is preferably from 5 nm to 20 nm, particularly preferably from 7 nm to 12 nm, for example from 8 nm to 10 nm. This regulates the oxygen content of the conductive layer in a particularly advantageous way.

In an advantageous design, the functional layer reflecting thermal radiation in this embodiment comprises a dielectric blocking layer against alkali diffusion below the electrically conductive layer, and optionally below the lower anti-reflective coating layer. The blocker layer reduces or prevents the diffusion of alkali ions from the glass substrate into the coating system. Alkali ions can negatively affect the properties of the functional layer reflecting thermal radiation. Furthermore, the blocker layer in interaction with the lower anti-reflective coating layer contributes advantageously to the adjustment of the optics of the overall coating structure. The refractive index of the blocking layer is preferably at least 1.9. Particularly good results are obtained if the refractive index of the blocking layer is from 1.9 to 2.5. The blocker layer preferably contains an oxide, a nitride or a carbide, preferably of tungsten, chromium, niobium, tantalum, zirconium, hafnium, titanium, silicon or aluminum, for example oxides such as Nb₂O₅, Bi₂O₃, TiO₂, Ta₂O₅, Y₂O₃, ZrO₂, HfO₂ SnO₂, or ZnSnOₓ, or nitrides such as AlN, TiN, TaN, ZrN or NbN. The blocking layer contains silicon nitride (Si₃N₄), in a particularly preferred form, which achieves particularly good results. The silicon nitride can have dopants and in a preferred additional form is doped with aluminum (Si₃N₄:Al), with titanium (Si₃N₄:Ti), with zirconium (Si₃N₄:Zr) or with boron (Si₃N₄:B). The thickness of the blocker layer is preferably from 10 nm to 50 nm, more preferably from 20 nm to 40 nm, for example from 25 nm to 35 nm. The blocker layer is preferably the lowermost layer of the layer stack; i.e., it has direct contact with the substrate surface, where it can develop its effect optimally.

In an advantageous design, the functional layer reflecting thermal radiation consists exclusively of layers with a refractive index of at least 1.9 or of at most 1.8, preferably at most 1.6. In a particularly preferred design, the functional layer reflecting thermal radiation consists only of the layers described and does not contain any other layers. The functional layer reflecting thermal radiation then consists of the following layers in the specified order starting from the substrate surface:
blocker layer against alkali diffusion
lower anti-reflective coating
electrically conductive layer
barrier layer to regulate oxygen diffusion
upper anti-reflective coating

The individual layers of the functional layer reflecting thermal radiation are deposited by methods known per se, preferably by magnetic field-assisted cathode sputtering. Sputtering takes place in an inert gas atmosphere, for example of argon, or in a reactive gas atmosphere, for example by adding oxygen or nitrogen. However, the layers may also be applied by other methods known to the person skilled in the art, for example by vapor deposition or chemical vapor deposition (CVD), by atomic layer deposition (ALD), by plasma-enhanced chemical vapor deposition (PECVD) or by wet chemical methods.

In this embodiment, in an advantageous design, a blocker layer against alkali diffusion is applied before the electrically conductive layer. In an advantageous design, a lower anti-reflective coating is applied before the electrically conductive layer and, if necessary, after the blocking layer. After the conductive layer, in an advantageous design, a barrier layer is applied to regulate oxygen diffusion. In an advantageous design, an upper anti-reflective coating is applied after the conductive layer and, if necessary, after the barrier layer.

To select suitable materials and layer thicknesses to realize functional layers reflecting near-infrared radiation, the person skilled in the art can, for example, make use of customary simulations.

For the selection of suitable materials and layer thicknesses to realize functional layers reflecting thermal radiation, the person skilled in the art can also use, for example, customary simulations.

If a first layer is arranged above a second layer, this means, in the sense of the invention, that the first layer is arranged further away from the substrate on which the coating is applied than the second layer. If a first layer is arranged below a second layer, this means, in the sense of the invention, that the second layer is arranged further away from the surface of the pane on which the functional layer is arranged than the first layer. The uppermost functional layer is the functional layer that is the greatest distance from the surface of the pane on which the functional layer is arranged. The lowermost functional layer is the functional layer that has the smallest distance to the surface of the sheet on which the functional layer is arranged.

If a first layer is arranged above or below a second layer, this does not necessarily mean, in the sense of the invention, that the first and the second layer are in direct contact with one another. One or more additional layers can be arranged between the first and the second layer, provided that this is not explicitly ruled out.

The indicated values for refractive indices are measured at a wavelength of 550 nm. Methods for determining refractive indices are known to the person skilled in the art. The refractive indices specified within the scope of the invention can be determined, for example, by ellipsometry, wherein commercially available ellipsometers can be used.

The functional layer reflecting near-infrared radiation and the functional layer reflecting thermal radiation are transparent to visible light. Within the meaning of the present invention, “transparent” means that the overall transmittance of the windshield complies with the legal requirements and preferably has a transmittance for visible light of more than 70% and, in particular, of more than 75%. Accordingly, “opaque” means a light transmission of less than 15%, preferably less than 5%, in particular 0%. The values for light transmittance (TL) refer (as is usual for automotive glazing) to illuminant A, i.e., the visible portion of sunlight at a wavelength of 380 nm to 780 nm, thus substantially the visible spectrum of solar radiation.

The outer pane and the inner pane of the windshield preferably comprise or consist of glass-particularly preferably flat glass, float glass, quartz glass, borosilicate glass, soda-lime glass, or clear plastics, preferably rigid clear plastics, and in particular polyethylene, polypropylene, polycarbonate, polymethyl methacrylate, polystyrene, polyamide, polyester, polyvinyl chloride and/or mixtures thereof.

The outer pane and the inner pane are preferably clear and colorless. Independently of one another, the outer pane and the inner panes can be not prestressed, partially prestressed or prestressed. If at least one of the panes should be prestressed, this can be thermal or chemical prestressing.

The thickness of the outer pane and of the inner pane can vary widely and adapted to the requirements of the individual case. Preferably, panes with the standard thicknesses of 1.0 mm to 25 mm and preferably of 1.4 mm to 2.1 mm are used. For example, the outer pane is 2.1 mm thick and the inner pane is 1.6 mm thick. However, the outer pane or, in particular, the inner pane can also be thin glass with a thickness of 0.55 mm, for example. The size of the outer pane and the inner pane can vary widely and depends on the use.

The thermoplastic intermediate layer contains or consists of at least one thermoplastic, preferably polyvinyl butyral (PVB), ethylene vinyl acetate (EVA) and/or polyethylene terephthalate (PET). The thermoplastic intermediate layer can, however, also contain, for example, polyurethane (PU), polypropylene (PP), polyacrylate, polyethylene (PE), polycarbonate (PC), polymethyl methacrylate, polyvinyl chloride, polyacetate resin, casting resin, acrylate, fluorinated ethylene propylene, polyvinyl fluoride, and/or ethylene tetrafluoroethylene, or a copolymer or mixture thereof. The thermoplastic intermediate layer can be designed by one or more thermoplastic films arranged one above the other, wherein the thickness of a thermoplastic film is preferably from 0.25 mm to 1 mm, typically 0.38 mm or 0.76 mm. The thermoplastic intermediate layer can also be a film with functional properties, for example a film with acoustic damping properties.

In a preferred embodiment, the radiation source is arranged such that the first reflection radiation has a radiation component that strikes perpendicular to the face of the vehicle user. Thereby, it can be advantageous if the first reflection radiation is reflected from a region of the windshield that results, at least in part, from a horizontal projection of the face of the vehicle user onto the windshield. The first reflection radiation can preferably strike the face of the vehicle user in a horizontal direction or along a vertical line. This enables very good recognition of details of the face of the vehicle user and, in particular, eye movements. Similarly, it is advantageous if the radiation receiver is arranged to receive reflected radiation (i.e., third reflection radiation) from the functional layer reflecting near-infrared radiation based on second reflection radiation, which has a radiation component that has been reflected perpendicularly from the face of the vehicle user. Advantageously, the third reflection radiation is reflected from a region of the windshield that results, at least in part, from a horizontal projection of the face of the vehicle user onto the windshield. The second reflection radiation can then preferably strike the functional layer reflecting near-infrared radiation in a horizontal direction or along a vertical line to the face of the vehicle user. This also enables very good recognition of details of the face of the vehicle user and eye movements in particular. Similarly, it is advantageous if the thermal imaging camera is arranged to receive reflected thermal radiation from the functional layer reflecting thermal radiation based on thermal radiation, which has a radiation component emitted perpendicularly from the face of the vehicle user. Advantageously, the thermal radiation emitted by the face of the vehicle user is reflected by a region of the windshield that results at least in part from a horizontal projection of the face of the vehicle user onto the windshield.

In a preferred embodiment, the radiation receiver and the thermal imaging camera are provided for detecting a facial state of the vehicle user, wherein the vehicle user whose facial state is detected is preferably the driver of the vehicle.

In a preferred embodiment of the arrangement according to the invention, the vehicle user is the driver of the vehicle.

In a further preferred embodiment, multiple faces may be captured by the radiation receiver and thermal imaging camera for monitoring purposes. In particular, the radiation receiver and the thermal imaging camera are provided for detecting a facial state of a driver and a facial state of a passenger of the vehicle.

In a particularly advantageous design, the radiation source, the radiation receiver and the thermal imaging camera are arranged centrally on the dashboard of the vehicle. Through this arrangement, multiple faces may be captured by the radiation receiver and thermal imaging camera for monitoring purposes. More expediently, in such an embodiment, the radiation receiver and the thermal imaging camera are provided for detecting a facial state of the driver and a facial state of the passenger.

The radiation source, radiation receiver and thermal imaging camera are typically independent components. However, the components may also be designed together as one module, i.e., one assembly unit.

In a preferred embodiment, the radiation source and the radiation receiver are designed as one module. In an alternative preferred embodiment, the radiation source and the thermal imaging camera are designed as one module. In a further alternative preferred embodiment, the radiation receiver and the thermal imaging camera are designed as one module. In a further alternative preferred embodiment, the radiation source, the radiation receiver, and the thermal imaging camera are designed as one module.

The invention further extends to a driver assistance system with a monitoring function for at least one vehicle user of a vehicle, which comprises an arrangement according to the invention. The driver assistance system further comprises at least one actuator and/or at least one signal output device, along with an electronic control device that is configured to determine information about the vehicle user on the basis of an output signal of the radiation receiver and on the basis of an output signal of the thermal imaging camera, and to output an electrical signal to the at least one actuator for performing a mechanical action and/or to the at least one signal output device for outputting a visual and/or acoustic signal on the basis of the determined information.

Furthermore, the invention extends to a method for monitoring at least one vehicle user of a vehicle, in particular for implementation in a driver assistance system according to the invention, comprising the following steps:
a) Emitting near-infrared radiation onto a functional layer reflecting near-infrared radiation of a windshield, such that near-infrared radiation reflected from the functional layer reflecting near-infrared radiation strikes the face of the vehicle user as first reflection radiation, wherein the first reflection radiation from the face of the vehicle user strikes the functional layer reflecting near-infrared radiation as second reflection radiation and is reflected from the functional layer reflecting near-infrared radiation as third reflection radiation,
b) Receiving the third reflection radiation and receiving thermal radiation emitted as reflected thermal radiation from a functional layer reflecting thermal radiation of the windshield reflected from the face of the vehicle user,
c) Determining information about the vehicle user,
d) Carrying out an action and/or outputting a visual and/or acoustic signal based on the determined information about the vehicle user.

It is understood that in step b), the third reflection radiation is received by a radiation receiver for receiving near-infrared radiation, and the reflected thermal radiation is received by a thermal imaging camera.

The preferred designs of the arrangement according to the invention described above also apply accordingly to the method according to the invention.

Furthermore, the invention extends to the use of the arrangement according to the invention in a driver assistance system for monitoring at least one vehicle user of a vehicle, in particular a motor vehicle, for traffic on land, water or in the air.

The various embodiments of the invention may be implemented individually or in any combinations. In particular, the features mentioned above and explained below can be used not only in the specified combinations but also in other combinations or alone without departing from the scope of the present invention.

In the following, the invention is explained in more detail with the aid of drawings and examples of embodiments. Elements that are identical or have the same effect are provided with the same reference signs. In a simplified, not-to-scale representation:

FIG. 1 shows a schematic view of the front part of a vehicle with a vehicle user with an arrangement according to the invention and a driver assistance system for monitoring at least one vehicle user,

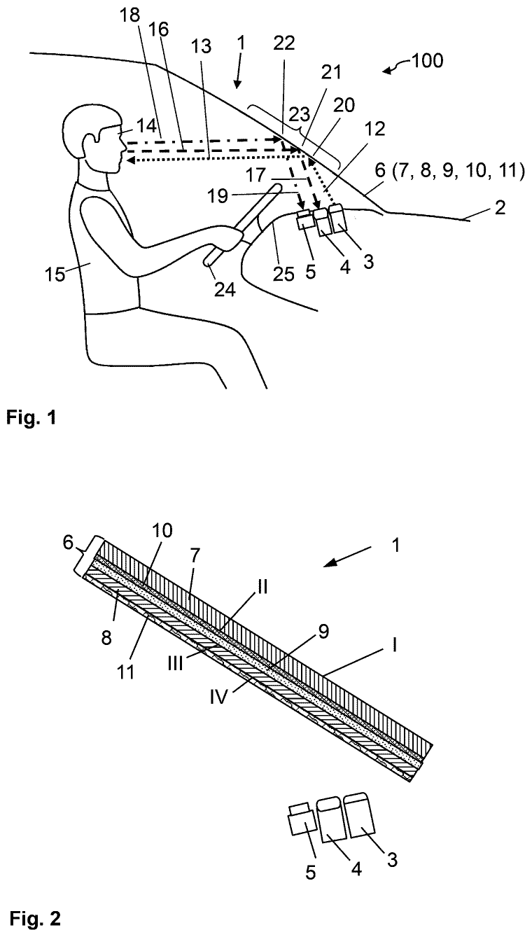

FIG. 2 shows a cross-section through an embodiment of an arrangement according to the invention,

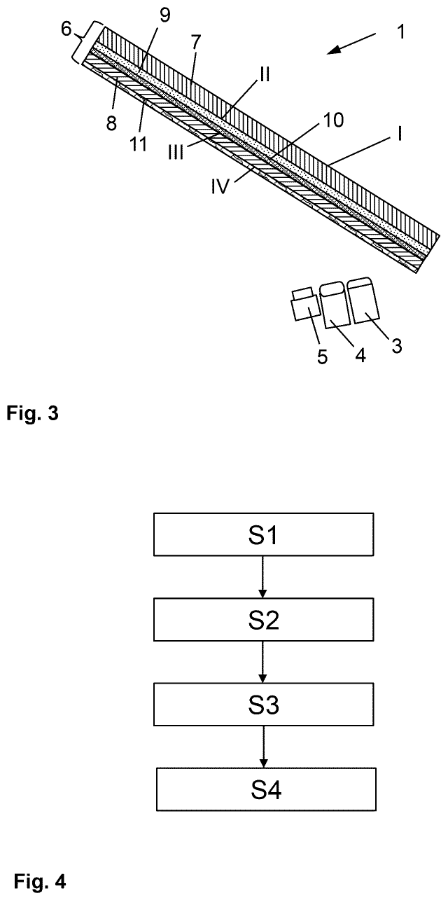

FIG. 3 shows a cross-section through a further embodiment of an arrangement according to the invention,

FIG. 4 shows a flowchart illustrating a method according to the invention for near-infrared-based monitoring of a driver of a vehicle,

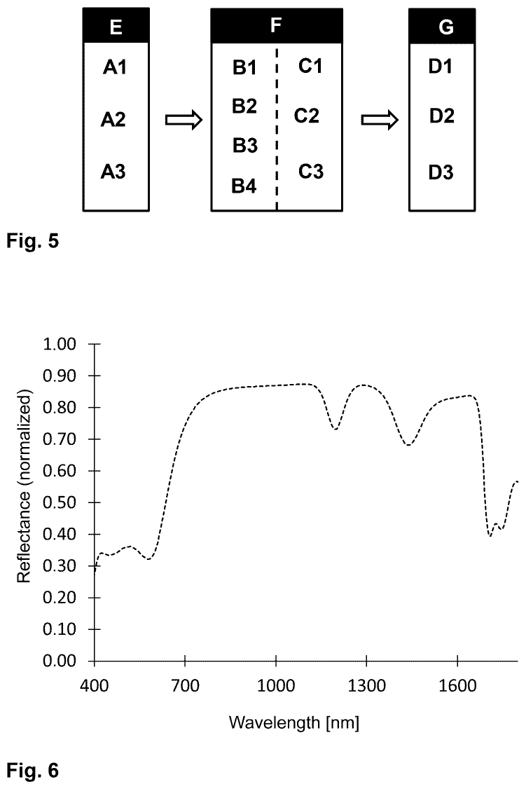

FIG. 5 shows a schematic view of the functional blocks of a driver assistance system according to the invention,

FIG. 6 shows reflection spectra of a windshield according to example H,

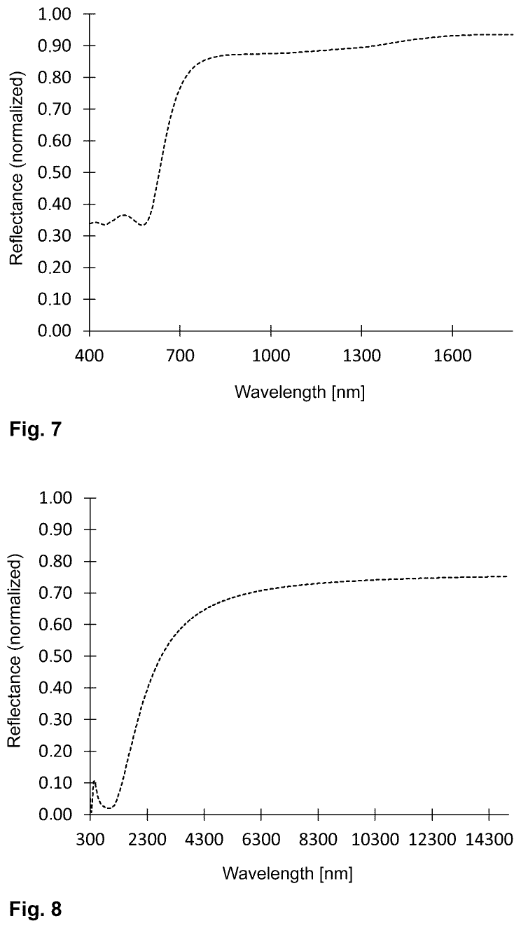

FIG. 7 shows reflection spectra of a windshield according to example J,

FIG. 8 shows reflection spectra of a windshield according to example K.

FIG. 1 shows a schematic view of the front part of a vehicle 2 with a vehicle user 15 with an arrangement 1 according to the invention and a driver assistance system 100 for monitoring at least one vehicle user 15.

The arrangement 1 according to the invention comprises a windshield 6 of a vehicle 2, which comprises an outer pane 7 and an inner pane 8, which are firmly connected to one another by a thermoplastic intermediate layer 9 and has both a functional layer reflecting near-infrared radiation 10 and a functional layer reflecting thermal radiation 11.

The arrangement 1 further comprises a radiation source 3 for near-infrared radiation, a radiation receiver 4 for near-infrared radiation and a thermal imaging camera 5, which, as shown schematically in FIG. 1, can be arranged side by side, but can also be installed in one module or alternatively in two modules. Both the radiation source 3 and the radiation receiver 4 along with the thermal imaging camera 5 are installed here, for example, in the rear region of the console 25, where they are practically invisible to vehicle users 15. The radiation source 3 is positioned and oriented such that the near-infrared radiation 12 emitted by the radiation source 3 is directed to the interior-side surface IV of the interior pane 8, where it is reflected by the functional layer reflecting near-infrared radiation 10 as first reflection radiation 13 toward the face 14 of the vehicle user 15. The near-infrared radiation 12 emitted by the radiation source 3 is reflected in a first sub-region 20 of the windshield 6 by the functional layer reflecting near-infrared radiation 10 and strikes the face 14 of the vehicle user 15 from the front as first reflection radiation 13. In particular, the first reflection radiation 13 has a radiation component that strikes the face 14 of the vehicle user 15 perpendicularly, i.e., in the horizontal direction, if the vehicle 2 is standing on a flat surface. From the face 14 of the vehicle user 15, the first reflection radiation 13 is reflected as second reflection radiation 16 in the direction of the functional layer reflecting near-infrared radiation 10. In particular, the second reflection radiation 16 has a radiation component that is reflected perpendicularly from the face 15 of the vehicle user 15, i.e., in the horizontal direction, if the vehicle 2 is standing on a flat surface. From the functional layer reflecting near-infrared radiation 10, the second reflection radiation 16 is reflected to the radiation receiver 4 as third reflection radiation 17. The third reflection radiation 17 is reflected by a second sub-region 21 of the windshield 6. The first sub-region 20 and the second sub-region 21 may partially overlap, fully overlap (i.e., be identical) or not overlap. The radiation receiver 4 is directed to the interior-side surface IV of the inner pane 8 and can receive the third reflection radiation 17 reflected from the functional layer reflecting near-infrared radiation 10. The thermal imaging camera 5 is directed to the interior-side surface IV of the inner pane 8. Thermal radiation 18 emitted by the face 14 of the vehicle user 15 strikes the functional layer reflecting thermal radiation 11 in a third sub-region 22 of the windshield 6 and is reflected by the latter as reflected thermal radiation 19 in the direction of the thermal imaging camera 5 and can be received by the thermal imaging camera 5. The first sub-region 20, the second sub-region 21 and the third sub-region 22 may partially overlap, fully overlap (i.e., be identical) or not overlap. The first sub-region 20, the second sub-region 21 and the third sub-region 22 together form the reflection region 23 of the windshield 6. The first sub-region 20 preferably corresponds to a region of the windshield 6 that faces the face 14 of the vehicle user 15 at least in sections, i.e., a region that results from a horizontal projection of the face 14 of the vehicle user 15 onto the windshield 6. Similarly, the second sub-region 21 preferably corresponds to a region of the windshield 6 that faces the face 14 of the vehicle user 15, at least in sections. Similarly, the third sub-region 22 preferably corresponds to a region of the windshield 6 that faces the face 14 of the vehicle user 15, at least in sections.

Based on the vehicle user data recorded in this way, information about the vehicle user 15 can be determined in a particularly reliable manner, since, on the one hand, the first reflection radiation 13 reflected by the functional layer 10 has, in particular, a radiation component that strikes the face 14 of the vehicle user 15 perpendicularly, and, on the other hand, the third reflection radiation 17 reflected by the functional layer 10 has, in particular, a radiation component that was reflected perpendicularly by the face 14 of the vehicle user 15. Thus, features of the face, such as facial expressions and eye movements, can be determined particularly well and reliably. Moreover, compared to prior art near-infrared radiation-based arrangements, an arrangement according to the invention can be used to determine additional information about the vehicle user 15 by means of the thermal imaging camera 5, such as the temperature of the face 14 of the vehicle user 15 and/or the thermal comfort of the vehicle user 15. This is a particular advantage of an arrangement according to the invention. In addition, the radiation source 3, the radiation receiver 4 and the thermal imaging camera 5 can be arranged in the rear region of the console 25, such that they can be easily integrated into the interior of the vehicle and do not interfere with the design of the vehicle interior.

FIG. 2 shows a cross-section through an embodiment of an arrangement 1 according to the invention. In the embodiment shown in FIG. 2, the arrangement 1 comprises a radiation source 3 for emitting near-infrared radiation, a radiation receiver 4 for receiving near-infrared radiation, a thermal imaging camera 5 and a windshield 6. The windshield 6 comprises an outer pane 7 with an outer-side surface I, an interior-side surface II and an inner pane 8 with an outer-side surface III and an interior-side surface IV, which are connected to one another via a thermoplastic intermediate layer 9. In addition, the windshield 6 has a functional layer reflecting near-infrared radiation 10 and a functional layer reflecting thermal radiation 11.

The outer pane 7 is made of green soda-lime glass, for example, and has a thickness of 2.1 mm, for example. The inner pane 8 is made of soda-lime glass, for example, and has a thickness of 1.6 m, for example. The thermoplastic intermediate layer 9 is made of PVB, for example, and has a thickness of 0.76 mm, for example.

In the embodiment of an arrangement 1 according to the invention shown in FIG. 2, the functional layer reflecting near-infrared radiation 10 is designed as a coating of the interior-side surface II of the outer pane 7, and the functional layer reflecting thermal radiation 11 is designed as a coating of the interior-side surface IV of the inner pane 8.

The functional layer reflecting near-infrared radiation 10 is constructed, for example, as shown in Table 1 or 2. For example, the functional layer reflecting thermal radiation 11 is constructed as shown in Table 3.

The radiation source 3, the functional layer reflecting near-infrared radiation 10, the functional layer reflecting thermal radiation 11, the thermal imaging camera 5 and the radiation receiver 4 are arranged such that near-infrared radiation 12 emitted from the radiation source 3 can be reflected from the functional layer reflecting near-infrared radiation 10 to the face 14 of the vehicle user 15 as first reflection radiation 13, the first reflection radiation 13 can be reflected from the face 14 of the vehicle user 15 to the functional layer reflecting near-infrared radiation 10 as second reflection radiation 16, and the second reflection radiation 16 reflected from the functional layer reflecting near-infrared radiation 10 as third reflection radiation 17 can be reflected to the radiation receiver 4 and can be received by the radiation receiver 4, and that thermal radiation 18 emitted from the face 14 of the vehicle user 15 can be reflected from the functional layer reflecting thermal radiation 11 as reflected thermal radiation 19 to the thermal imaging camera 5 and can be received by the thermal imaging camera 5.

For simplified illustration, FIG. 2 does not show the vehicle user 15, the near-infrared radiation 12 emitted from the radiation source 3, the first reflection radiation 13, the second reflection radiation 16, the third reflection radiation 17, the thermal radiation 18 emitted from the face 14 of the vehicle user 15 and the thermal radiation 19 reflected from the functional layer reflecting thermal radiation 11.

FIG. 3 shows a cross-section through a further embodiment of an arrangement 1 according to the invention. The embodiment shown in FIG. 3 differs from that shown in FIG. 2 only in that the functional layer reflecting near-infrared radiation 10 is not designed as a coating of the interior-side surface II of the outer pane 7, but as a coating of the outer-side surface III of the inner pane 8.

FIG. 4 illustrates a method according to the invention for monitoring at least one vehicle user.

The method comprises at least the following method steps in the order given below:
S1 Emitting near-infrared radiation 12 onto a functional layer reflecting near-infrared radiation 10 of a windshield 6, such that near-infrared radiation reflected from the functional layer reflecting near-infrared radiation 10 strikes the face 14 of a vehicle user 15 as first reflection radiation 13, wherein the first reflection radiation 13 from the face 14 of the vehicle user 15 strikes the functional layer reflecting near-infrared radiation 10 as second reflection radiation 16 and is reflected from the functional layer reflecting near-infrared radiation 10 as third reflection radiation 17;
S2 Receiving the third reflection radiation 17 and receiving thermal radiation 18 emitted as reflected thermal radiation 19 from a functional layer reflecting thermal radiation 11 reflected from the face of the vehicle user 15,
S3 Determining information about the vehicle user 15,
S4 Carrying out an action and/or outputting a visual and/or acoustic signal based on the determined information about the vehicle user 15.

FIG. 5 schematically illustrates the functional components of a driver assistance system 100 according to the invention with a monitoring function for at least one vehicle user 15 based on near-infrared radiation and thermal radiation. Thereby, block E represents the portion of the driver assistance system 100 concerning the application of near-infrared radiation and thermal radiation, block F represents the processing of the signal data captured thereby to determine information about the vehicle user 15, and block G represents possible actions based on the determined information about the vehicle user 15.

In block E, step A1, near-infrared radiation is emitted by the radiation source 3 in the direction of the windshield 6 and reflected by the functional layer reflecting near-infrared radiation 10 in the direction of the face 14 of the vehicle user 15, and in step A2, the near-infrared radiation reflected by the face 14 of the vehicle user 15 is reflected by the functional layer reflecting near-infrared radiation 10 in the direction of the radiation receiver 4 and received by the radiation receiver 4. Moreover, in block E, step A3, thermal radiation emitted from the face 14 of the vehicle user 15 is reflected by the functional layer reflecting thermal radiation 11 to the thermal imaging camera 5 and received by the thermal imaging camera 5. In block F, which is implemented in the vehicle 2 by an electronic control unit (ECU), information about the vehicle user 15 is determined using algorithms known per se, in this case, for example, a head position (B1) and an eye position (B2) of the vehicle user 15. In addition, identification (B3) of the vehicle user 15 is performed, for example, on the basis of preset personalized personal data. In addition, suitable algorithms can be used to determine further information about the vehicle user 15, such as the presence of fatigue or drowsiness (C1), which can be captured in particular on the basis of a reduced frequency of eye movements, or excessive distraction (C2), which can be recognized, for example, by directions of gaze that are not primarily directed forwards and thus do not serve to guide the vehicle. The state thereby determined can in particular also be subjected to personalization (C3) in order to be able to determine person-specific information, which presupposes that the vehicle user (B3) has been identified. In block G, as a result of determining information about the vehicle user 15 using actuators, an intervention in the vehicle guidance may be performed. For example, a steering intervention for keeping in a lane (D1) occurs if fatigue, in particular microsleep, has been recognized in the vehicle user 15 who is the driver of the vehicle. Alternatively or additionally, an acoustic and/or visual signal (D2) can be output by a signaling device, for example a visual indication that drowsiness has been detected in the driver, possibly supported by an acoustic warning signal. Alternatively or additionally, for example, the air conditioning or heating system of the vehicle can be controlled based on the determined facial temperature of the vehicle user 15 (D3).

The invention is explained below with reference to reflection spectra of windshields with a functional layer reflecting near-infrared radiation (examples H and K) and of a windshield with a functional layer reflecting thermal radiation (example J).

The coating sequence and the coating thicknesses in the windshields are given in Tables 1 to 3.

TABLE 1
Example H

| Material | Thickness | |
|---|---|---|
| Soda-lime glass | 2.1 | mm |
| SiZrNₓ | 10.9 | nm |
| ZnSnOₓ | 7.0 | nm |
| ZnO | 13.0 | nm |
| Ag | 9.5 | nm |
| NiCr | 0.2 | nm |
| ZnO | 12.0 | nm |
| SiZrNₓ | 42.5 | nm |
| ZnSnOₓ | 8.0 | nm |
| ZnO | 9.0 | nm |
| Ag | 9.5 | nm |
| NiCr | 0.3 | nm |
| ZnO | 10.0 | nm |
| Si₃N₄ | 25.8 | nm |
| SiZrNₓ | 21.3 | nm |
| ZnSnOₓ | 7.0 | mm |
| ZnO | 14.0 | nm |
| Ag | 9.0 | nm |
| NiCr | 0.2 | nm |
| ZnO | 13.0 | nm |
| Si₃N₄ | 9.9 | nm |
| SiZrNₓ | 9.0 | nm |
| PVB | 0.76 | mm |
| Soda-lime glass | 1.6 | mm |

Table 1 shows the layered structure of a windshield with a functional layer reflecting near-infrared radiation, which is applied as a coating to the interior-side surface of the outer pane.

TABLE 2
Example J

| Material | Thickness | |
|---|---|---|
| Soda-lime glass | 2.1 | mm |
| PVB | 0.76 | mm |
| SiZrNₓ | 9.0 | nm |
| Si₃N₄ | 9.9 | nm |
| ZnO | 13.0 | nm |
| NiCr | 0.2 | nm |
| Ag | 9.0 | nm |
| ZnOI | 14.0 | nm |
| ZnSnOₓ | 7.0 | mm |
| SiZrNₓ | 21.3 | nm |
| Si₃N₄ | 25.8 | nm |
| ZnOI | 10.0 | nm |
| NiCr | 0.3 | nm |
| Ag | 9.5 | nm |
| ZnO | 9.0 | nm |
| ZnSnOₓ | 8.0 | nm |
| SiZrNₓ | 42.5 | nm |
| ZnO | 12.0 | nm |
| NiCr | 0.2 | nm |
| Ag | 9.5 | nm |
| ZnO | 13.0 | nm |
| ZnSnOₓ | 7.0 | nm |
| SiZrNₓ | 10.9 | nm |
| Soda-lime glass | 1.6 | mm |

Table 2 shows the layered structure of a windshield with a functional layer reflecting near-infrared radiation, which is applied as a coating to the outer-side surface of the inner pane.

TABLE 3
Example K

| Material | Thickness | |
|---|---|---|
| Soda-lime glass | 2.1 | mm |
| PVB | 0.76 | mm |
| Soda-lime glass | 2.1 | mm |
| Si₃N₄ | 30.0 | nm |
| SiO₂ | 17.0 | nm |
| ITO | 72.0 | nm |
| Si₃N₄ | 9.0 | nm |
| SiO₂ | 50.0 | nm |

Table 3 shows the layered structure of a windshield with a functional layer reflecting thermal radiation, which is applied as a coating to the interior-side surface of the inner pane.

The reflectance describes the portion of the total radiation irradiated onto the windshield from the inside that is reflected. It is indicated in % (based upon 100%-emitted radiation) or as a unitless number from 0 to 1 (normalized to the emitted radiation). It forms the reflection spectrum when plotted as a function of the wavelength.

The reflection spectrum of example H is shown in FIG. 6. From the reflectance spectrum shown in FIG. 6, it can be seen that the windshield according to Example H has a high reflectance to near-infrared radiation with wavelengths in the range of 800 nm to 1600 nm and has a low reflectance to visible light.

The reflection spectrum of example J is shown in FIG. 7. From the reflectance spectrum shown in FIG. 7, it can be seen that the windshield according to Example J has a high reflectance to near-infrared radiation with wavelengths in the range of 800 nm to 1600 nm and has a low reflectance to visible light.

The reflection spectrum of example K is shown in FIG. 8. It can be seen from the reflectance spectrum shown in FIG. 8 that the windshield according to Example K has a high reflectance with respect to thermal radiation with wavelengths in the range from 5 μm to 14 μm, preferably 7 μm to 14 μm, particularly preferably 9 μm to 14 μm, and a low reflectance with respect to visible light and with respect to near-infrared radiation with wavelengths in the range from 800 nm to 2500 nm.

### LIST OF REFERENCE SIGNS

1 Arrangement
2 Vehicle
3 Radiation source
4 Radiation receiver
5 Thermal imaging camera
6 Windshield
7 Outer pane
8 Inner pane
9 Thermoplastic intermediate layer
10 Functional layer reflecting near-infrared radiation
11 Functional layer reflecting thermal radiation
12 Near-infrared radiation emitted by the radiation source 3
13 First reflection radiation
14 Face
15 Vehicle user
16 Second reflection radiation
17 Third reflection radiation
18 Emitted thermal radiation
19 Reflected thermal radiation
20 First sub-region
21 Second sub-region
22 Third sub-region
23 Reflection region
24 Steering wheel
25 Console
100 Driver assistance system

1. An arrangement for a driver assistance system of a vehicle for monitoring at least one vehicle user, comprising:
a radiation source for emitting near-infrared radiation,
a radiation receiver for receiving near-infrared radiation,
a thermal imaging camera, and
a windshield comprising an outer pane with an outer-side surface and an interior-side surface and an inner pane with an outer-side surface and an interior-side surface, which are connected to one another via a thermoplastic intermediate layer, wherein a functional layer reflecting near-infrared radiation is arranged on the interior-side surface of the outer pane or on the outer-side surface of the inner pane, and a functional layer reflecting thermal radiation is arranged on the interior-side surface of the inner pane,
and wherein the radiation source, the functional layer reflecting near-infrared radiation, the functional layer reflecting thermal radiation, the thermal imaging camera and the radiation receiver are arranged such
that near-infrared radiation emitted by the radiation source can be reflected by the functional layer reflecting near-infrared radiation as first reflection radiation onto the face of the vehicle user, the first reflection radiation can be reflected by the face of the vehicle user as second reflection radiation to the functional layer reflecting near-infrared radiation, and the second reflection radiation reflected by the functional layer reflecting near-infrared radiation as third reflection radiation can be reflected to the radiation receiver and can be received by the radiation receiver,
and that thermal radiation emitted by the face of the vehicle user is reflected by the functional layer reflecting thermal radiation as reflected thermal radiation to the thermal imaging camera and can be received by the thermal imaging camera.

2. The arrangement according to claim 1, wherein the functional layer reflecting near-infrared radiation is arranged on the interior-side surface of the outer pane.

3. The arrangement according to claim 1, wherein the functional layer reflecting near-infrared radiation is arranged on the outer-side surface of the inner pane.

4. The arrangement according to claim 1, wherein the functional layer reflecting near-infrared radiation and the functional layer reflecting thermal radiation extend over substantially the entire area of the windshield.

5. The arrangement according to claim 1, wherein the functional layer reflecting near-infrared radiation and the functional layer reflecting thermal radiation are arranged in a sub-region of the windshield.

6. The arrangement according to claim 1, wherein the functional layer reflecting near-infrared radiation comprises a layer system with at least one metal layer embedded between dielectric oxide or nitride layers.

7. The arrangement according to claim 6, wherein the functional layer reflecting near-infrared radiation comprises a layer system with three silver layers embedded between dielectric oxide or nitride layers.

8. The arrangement according to claim 1, wherein the functional layer reflecting thermal radiation comprises a transparent conductive oxide.

9. The arrangement according to claim 1, wherein the radiation receiver and the thermal imaging camera are provided for detecting a facial state of the vehicle user.

10. The arrangement according to claim 1, wherein the vehicle user is a driver of the vehicle.

11. The arrangement according to claim 1, wherein the radiation receiver and the thermal imaging camera are provided for detecting a facial state of a driver and a facial state of a passenger of the vehicle.

12. The arrangement according to claim 1, wherein the radiation source and the radiation receiver are designed as one module, or wherein the radiation source and the thermal imaging camera are designed as one module, or wherein the radiation receiver and the thermal imaging camera are designed as one module, or wherein the radiation source, the radiation receiver and the thermal imaging camera are designed as one module.

13. A driver assistance system with a monitoring function for at least one vehicle user of a vehicle, comprising
an arrangement according to claim 1,
at least one actuator and/or at least one signal output device,
an electronic control device that is configured to determine information about the vehicle user on the basis of an output signal of the radiation receiver and an output signal of the thermal imaging camera, and to output an electric signal to the at least one actuator for performing a mechanical action and/or to the at least one signal output device for outputting a visual and/or acoustic signal on the basis of the determined information.

14. A method for monitoring at least one vehicle user of a vehicle, comprising:
a) emitting near-infrared radiation onto a functional layer reflecting near-infrared radiation of a windshield, such that near-infrared radiation reflected from the functional layer reflecting near-infrared radiation strikes the face of the vehicle user as first reflection radiation, wherein the first reflection radiation from the face of the vehicle user strikes the functional layer reflecting near-infrared radiation as second reflection radiation and is reflected by the functional layer reflecting near-infrared radiation as third reflection radiation;
b) receiving the third reflection radiation and receiving thermal radiation emitted as reflected thermal radiation from a functional layer reflecting thermal radiation of the windshield reflected from the face of the vehicle user;
c) determining information about the vehicle user; and
d) carrying out an action and/or outputting a visual and/or acoustic signal based on the determined information about the vehicle user.

15. A method comprising providing an arrangement according to claim 1 in a driver assistance system for monitoring at least one vehicle user of a vehicle for traffic on land, water or in the air.

16. The arrangement according to claim 6, wherein the at least one metal layer is a metallic silver layer.

17. The arrangement according to claim 8, wherein the transparent conductive oxide comprises indium tin oxide, indium zinc mixed oxide (IZO), gallium-doped tin oxide (GZO), fluorine-doped tin oxide (SnO₂:F) or antimony-doped tin oxide (SnO₂:Sb).

18. The arrangement according to claim 17, wherein the transparent conductive oxide is indium tin oxide.
